(19) United States
(12) Patent Application Publication
(10) Pub. No.: US 2025/0036937 A1
(43) Pub. Date: Jan. 30, 2025

(54) FEATURE MANAGEMENT

(71) Applicant: Lemon Inc., Grand Cayman (KY)

(72) Inventors: Zhe LIU, Los Angeles, CA (US); Silun WANG, Los Angeles, CA (US); Xiaoteng LU, Los Angeles, CA (US); Wenting YE, Los Angeles, CA (US); Yue ZHUANG, Los Angeles, CA (US); Huang ZOU, Los Angeles, CA (US); Meng XIN, Los Angeles, CA (US); Yu ZHANG, Los Angeles, CA (US); Bin LIU, Los Angeles, CA (US)

(21) Appl. No.: 18/359,643

(22) Filed: Jul. 26, 2023

(51) Int. Cl. G06N 3/08; G06N 3/0455

(52) U.S. Cl. CPC G06N 3/08; G06N 3/0455

(57) ABSTRACT

There are proposed methods, devices, and computer program products for feature management. In the method, a first event associated with a first and a second object, and a second event associated with the first and second events are obtained, and a type of the first event is different from a type of the second event. A first feature of the first object is determined based on a first encoder, and a second feature of the second object is determined based on a second encoder. The first encoder is updated based on the first and second features and the first and second events. With these implementations, multiple events are used in determining the encoder for extracting the feature, and thus the encoder may have better performance in accuracy and increase performance of downstream tasks.

### FIELD

The present disclosure generally relates to feature management, and more specifically, to methods, devices and computer program products for feature management based on events occur in multiple time windows.

### BACKGROUND

Nowadays, the machine learning technique has been widely used in data processing. For example, in a recommendation environment, data such as an advertisement, a message, an audio, a video, a game and so on may be provided to users. Then, the users may subscript a channel in which the data is provided, buy a commodity that is recommended in the data, and so on. At this point, events between the user and the channel, the commodity and the like may be detected. There have been proposed solutions for generating features for the user and data and then predicting a trend of events in the future. However, these solutions heavily depend on whether features for the user and the data can accurately represent attributes of the user and the data. At this point, how to build encoders for determining features for the user and the data in a more effective way becomes a hot focus.

### SUMMARY

In a first aspect of the present disclosure, there is provided a method for feature management. The method comprises: obtaining a first event associated with a first and a second object, and obtaining a second event associated with the first and second events, a type of the first event being different from a type of the second event; determining a first feature of the first object based on a first encoder, and determining a second feature of the second object based on a second encoder; and updating the first encoder based on the first and second features and the first and second events.

In a second aspect of the present disclosure, there is provided an electronic device. The electronic device comprises: a computer processor coupled to a computer-readable memory unit, the memory unit comprising instructions that when executed by the computer processor implements a method according to the first aspect of the present disclosure.

In a third aspect of the present disclosure, there is provided a computer program product, the computer program product comprising a computer readable storage medium having program instructions embodied therewith, the program instructions executable by an electronic device to cause the electronic device to perform a method according to the first aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

Through the more detailed description of some implementations of the present disclosure in the accompanying drawings, the above and other objects, features and advantages of the present disclosure will become more apparent, wherein the same reference generally refers to the same components in the implementations of the present disclosure.

FIG. 1 illustrates an example environment for feature management according to the machine learning technique;

FIG. 2 illustrates an example diagram of events that occur at diffident time points according to implementations of the present disclosure;

FIG. 3 illustrates an example diagram of a predication model according to implementations of the present disclosure;

FIG. 4 illustrates an example diagram of a detailed predication model according to implementations of the present disclosure;

FIG. 5 illustrates an example diagram for training a predication model according to implementations of the present disclosure;

FIG. 6 illustrates an example diagram of a data repository according to implementations of the present disclosure;

FIG. 7 illustrates an example diagram of a batch of training samples according to implementations of the present disclosure;

FIG. 8 illustrates an example flowchart of a method for feature management according to implementations of the present disclosure; and

FIG. 9 illustrates a block diagram of a computing device in which various implementations of the present disclosure can be implemented.

### DETAILED DESCRIPTION

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one implementation,” “an implementation,” “an example implementation,” and the like indicate that the implementation described may include a particular feature, structure, or characteristic, but it is not necessary that every implementation includes the particular feature, structure, or characteristic. Moreover, such phrases are not necessarily referring to the same implementation. Further, when a particular feature, structure, or characteristic is described in connection with an example implementation, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

It may be understood that data involved in the present technical solution (including but not limited to the data itself, the acquisition or use of the data) should comply with requirements of corresponding laws and regulations and relevant rules.

It may be understood that, before using the technical solutions disclosed in various implementation of the present disclosure, the user should be informed of the type, scope of use, and use scenario of the personal information involved in the present disclosure in an appropriate manner in accordance with relevant laws and regulations, and the user's authorization should be obtained.

For example, in response to receiving an active request from the user, prompt information is sent to the user to explicitly inform the user that the requested operation will need to acquire and use the user's personal information. Therefore, the user may independently choose, according to the prompt information, whether to provide the personal information to software or hardware such as electronic devices, applications, servers, or storage media that perform operations of the technical solutions of the present disclosure.

As an optional but non-limiting implementation, in response to receiving an active request from the user, the way of sending prompt information to the user, for example, may include a pop-up window, and the prompt information may be presented in the form of text in the pop-up window. In addition, the pop-up window may also carry a selection control for the user to choose “agree” or “disagree” to provide the personal information to the electronic device.

It may be understood that the above process of notifying and obtaining the user authorization is only illustrative and does not limit the implementation of the present disclosure. Other methods that satisfy relevant laws and regulations are also applicable to the implementation of the present disclosure.

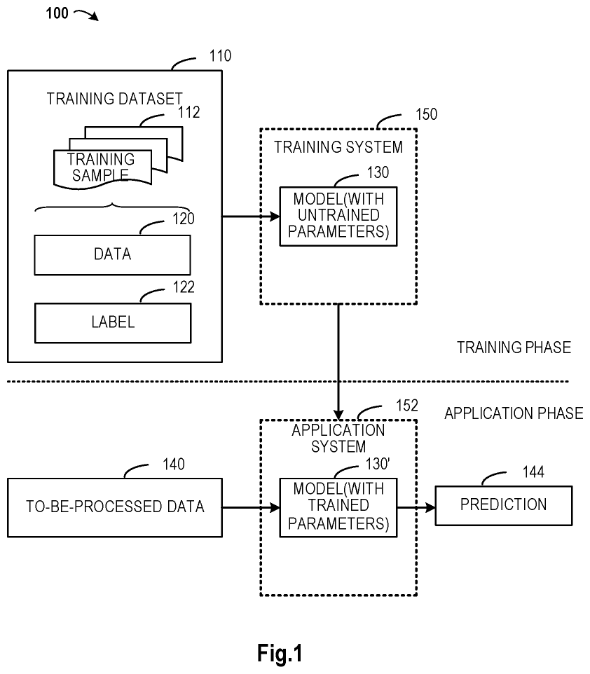

For the purpose of description, the following paragraphs will provide more details by taking a recommendation system as an example environment. In the recommendation system, various data may be sent to the user. Sometimes, the user is interested in the data and then performs a subscription or place an order. If the user is not interested in the data, he/she may pass the data and do nothing. By now, solutions have been provided for generating an event model for predicting events related to the data in the future. Hereinafter, reference will be made to FIG. 1 for more details about the event model, here FIG. 1 illustrates an example environment 100 for feature management according to the machine learning technique.

In FIG. 1, a model 130 may be provided for the event processing. Here, the environment 100 includes a training system 150 and an application system 152. The upper portion of FIG. 1 shows a training phase, and the lower portion shows an application phase. Before the training phase, the model 130 may be configured with untrained or partly trained parameters (such as initial parameters, or pre-trained parameters). In the training phase, the model 130 may be trained in the training system 150 based on a training dataset 110 including a plurality of training samples 112. Here, each training sample 112 may have a two-tuple format, and may include data 120 (for example, data associated with the object and the events related to the object) and a label 122 for the event. Specifically, a large amount of training sample 112 may be used to implement the training phase iteratively. After the training phase, the parameters of the model 130 may be updated and optimized, and a model 130′ with trained parameters may be obtained. At this point, the model 130′ may be used to implement the predication task in the application phase. For example, the to-be-processed data 140 may be inputted into the application system 152, and then a corresponding prediction 144 may be Outputted.

In FIG. 1, the model training system 150 and the model application system 152 may include any computing system with computing capabilities, such as various computing devices/systems, terminal devices, servers, and so on. The terminal device may involve any type of mobile device, fixed terminal, or portable device, including mobile phones, desktop computers, laptop computers, notebook computers, netbook computers, tablet computers, media computers, multimedia tablets, or any combination of the foregoing, including the accessories and peripherals of these devices or any combination thereof. Servers may include but are not limited to mainframes, edge computing nodes, computing devices in cloud environments, and so on. It should be understood that the components and arrangements in the environment 100 in FIG. 1 are only examples, and a computing system suitable for implementing the example implementation described in the present disclosure may include one or more different components, and other components. For example, the training system 150 and the application system 152 may be integrated in the same system or device.

As illustrated in FIG. 1, the training dataset 110 may include historical training sample 112 collected from data logs of the recommendation system according to requirements of corresponding laws and regulations and relevant rules. However, the performance of the model 130′ is closely associated with whether features (such as embeddings) of the training sample 112 may correctly reflect various aspects of the training sample 112. If the features of the training sample 112 is correct and rich, then the performance of the model 130′ may be increased.

Multiple solutions have been proposed for extracting features from the training sample 112 by encoders. However, the extracted features can only reflect a trend of events within a short time period. At this point, it is desired that features may be extracted in a more effective and accurate way, such that performance of the downstream task may be increased.

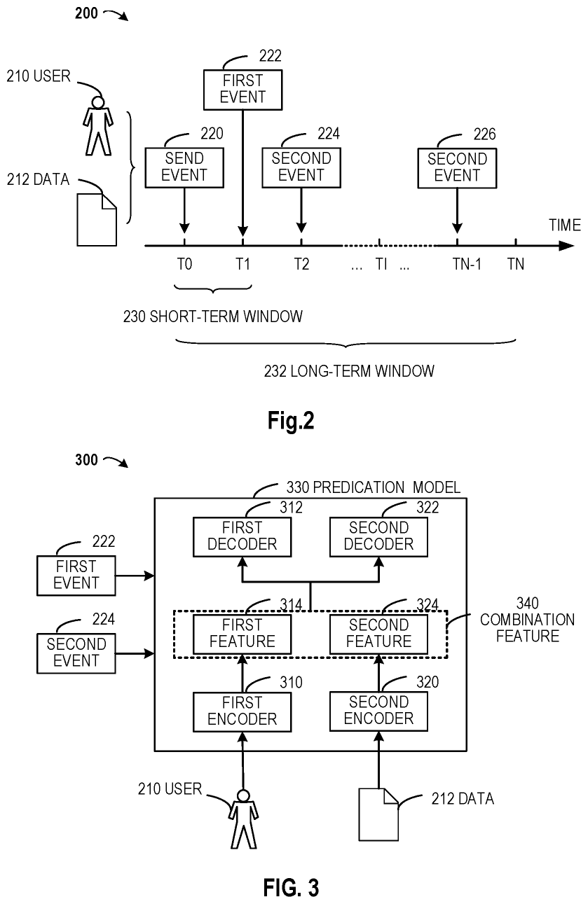

In view of the above, the present disclosure proposes feature management solution based on multiple events related to multiple time windows. For example, events occur in both of a short-term window and a long-term window are considered in determining the feature. Reference will be made to FIG. 2 for events that occur in the data recommendation system, here FIG. 2 illustrates an example diagram 200 of events that occur at diffident time points according to implementations of the present disclosure.

Multiple objects may be involved in the recommending system, for example, a first object may correspond to one of the user and the data (such as an advertisement, a message, an audio, a video, a game, and the like), and the second object may correspond to the other one of the user and the data. In the following paragraphs, the user and the advertisement will be taken as examples of the first and second objects for description. Alternatively and/or in addition, an order of the first and second objects may be switched.

During operations of the recommending system, various data may be provided to the user. As shown in FIG. 2, the data 212 may be sent to the user 210 at a time point TO (called as a send event 220), for example, the data 212 may be displayed at a terminal device of the user 210. Then, multiple events associated with the user 210 and the data 212 may occur. For example, a first event 222 (for example, an event indicates that the user 220 clicks or opens the data 212) may occur at a time point T1. Further, deeper events (also referred to as second events) may occur after the first event 222. In FIG. 2, a second event 224 and a second event 226 associated with the user 210 and the data 212 may occur at subsequent time points T2 and Tn−1, respectively. For example, the second event 224 may indicate that the user 210 adds a commodity promoted in the data 212 into the shopping bag, and the second event 226 may indicate that the user 210 places an order and buys the commodity.

It is to be understood that all the information about the user, the data and the events do not include any sensitive information. For example, all the information may be collected according to requirements of corresponding laws and regulations and relevant rules, and then may be converted into an invisible format (such as embeddings) for the protection purpose.

In the context of the present disclosure, the first event 222 may be referred to as the click event, and the second events 224 and 226 may be referred to as the conversion events, and the conversion event here indicates that the user behavior is converted towards a deeper interaction with the recommendation system. Usually, a conversion rate (CVR) is a key factor for measure whether the data 212 attracts the user's attention. Therefore, the conversion events that occur after the click event is considered in generating the object features.

As shown in FIG. 2, the timeline may be divided into a short-term window 230 (for example, one day or another time length after the send event) and a long-term window 232 (for example, more than one day or another time length where the conversion event more likely occurs in the long-term window 232). Here, events associated with multiple time windows may be used for the training procedure. In implementations of the present disclosure, the click event and the conversion may cover different time durations, and thus rich information about various events are considered in the training procedure. Accordingly, the trained model may provide more accurate features for both of the user 210 and the data 212.

In implementations of the present disclosure, the first event 222 may be directly obtained, for example, from the data log of the recommendation system. Due to the second event 224 may involve a long-term window in the future, the obtaining the second event 224 relates to two situations: the second event 224 may be a really monitored event or a predicted event outputted by an event prediction model. For example, with respect to a conversion event that occurs within a short duration (for example, several hours, one day, or the like) after the click event, the conversion event may be directly obtained. In another example, with respect to a conversion event that occurs within a long duration (for example, more than one day, or the like) after the click event, an event prediction model may be used for predicting whether a conversion event will occur. The event prediction model may be pretrained and may output the prediction based on other actions performed by the user. For example, the event prediction mode may be implemented based on the soft-label distillation technique. With these implementations, the model may be trained by recently collected second events and the predicted second events without a need for delaying the training procedure by several days.

Hereinafter, referring to FIG. 3 for more details about the feature management. FIG. 3 illustrates an example diagram 300 of a predication model 330 according to implementations of the present disclosure. As shown in FIG. 3, a predication model 330 is generated, where the first encoder 310 is used for receiving information about the user 210, and the second encoder 320 is used for receiving information about the data 212. Further, the prediction model 330 has two heads for predicting: the first decoder 312 is for predicting the first event (i.e., the click event), and the second decoder 322 is for predicting the second event (i.e., the conversion event).

Generally, the first event 222 (for example, a click event) associated with a first and a second object, and the second event 224 (for example, a conversion event that occurs after the first event) associated with the first and second events may be obtained. Here, a type of the first event may be different from a type of the second event. Specifically, the first and second events may be received from the data log of the recommendation system. Alternatively and/or in addition, the second event may be a predicted one. Then, a first feature 314 of the first object (for example, the user 210) may be determined based on the first encoder 310, and a second feature 324 of the second object (for example, the data 212) may be determined based on the second encoder 320.

Further, the first and second features 314 and 324 may be combined into a combination feature 340 and then inputted into the first and second decoders 312 and 322. The first and second decoders 312 and 322 may output respective predications for the first and second events 222 and 224, and then respective losses may be determined and then used for updating the first and second encoders 310 and 320. In other words, the first encoder 310 and/or the second encoder 320 may be updated based on the first and second features 314 and 324 and the first and second events 222 and 224.

With these implementation, various types of events are used in updating the first and second encoders 310 and 320, therefore the user feature extracted by the first encoder 310 and the data feature extracted by the second encoder 320 may represent influence of both of the click event and the conversion event. Accordingly, the extracted features may be more accurate in representing information related to both of the click and conversion events, thereby improving the accuracy of downstream tasks.

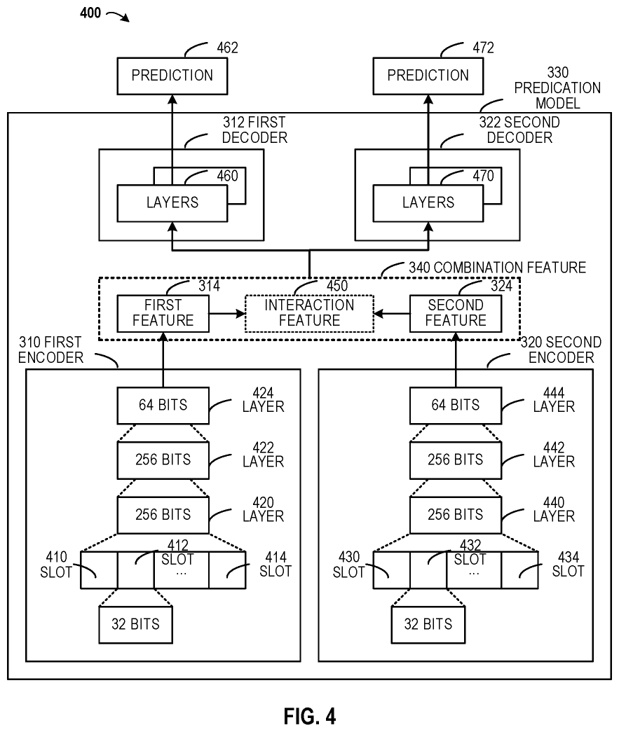

Having provided the brief of the prediction model 330, reference will be made to FIG. 4 for more details. FIG. 4 illustrates an example diagram 400 of a detailed predication model according to implementations of the present disclosure. As shown in FIG. 4, the first encoder 310 may have a multiple-layer hierarchical structure. For example, the bottom layer may include multiple slots 410, 412, . . . , and 414 for receiving respective attributes of the user 210, and each slot may be represented by 32 bits (or a different width). Depending on a specific environment, the attributes of the user 210 may include different information, for example, a user ID for uniquely identifying each user, and so on. It is to be understood that all the attributes may be collected according to requirements of corresponding laws and regulations and relevant rules, and then may be converted into an invisible format (such as embeddings) for the protection purpose. Further, the bottom layer may be converted into the layer 420 according to parameters of the first encoder 310, for example, various operations such as convolution, polling, and the like may be implemented. Similarly, the layer 420 may be converted into the layer 422, and then converted into the layer 424. In other words, the first encoder 310 may accept attributes of the user 210 at the bottom layer and then output the first feature 314 with 64 bits.

The second encoder 320 may have a similar hierarchical structure, specifically, the bottom layer in the second encoder 320 may receive respective attributes of the data 212, and each of the slots 430, 432, . . . , and 434 may be represented by 32 bits (or a different width). Depending on a specific environment, the attributes of the data 212 may include different information, for example, a data ID for uniquely identifying each data, a size of the data, and other information. It is to be understood that all the attributes may be collected according to requirements of corresponding laws and regulations and relevant rules, and then may be converted into an invisible format (such as embeddings) for the protection purpose. Further, the bottom layer may be converted into the layer 440 according to parameters of the second encoder 320. Similarly, the layer 440 may be converted into the layer 442, and then converted into the layer 444. In other words, the second encoder 320 may accept attributes of the data 212 at the bottom layer and then output the second feature 324 with 64 bits. Although FIG. 4 shows that both of the first and second encoders 310 and 320 have 3 layers, alternatively and/or in addition, these encoders may have hierarchical structures different from FIG. 4.

In some implementations of the present disclosure, the first and second features 314 and 324 may be combined into the combination feature 340. Specifically, the first and second features 314 and 324 may be concatenated to form the combination feature 340. Alternatively and/or in addition, an interaction feature 450 may be determined based on the first and second features 314 and 324, for example, a production may be determined for the first and second features 314 and 324. Then, a concatenation may be determined for the first feature 314, the interaction feature 450, and the second feature 324 to generate the combination feature 340.

With these implementations, the combination feature 340 may reflect more interaction information between the user 210 and the data 212, and thus the prediction model 330 may be optimized in a more accurate way. It is to be understood that sequence of the first feature 314, the interaction feature 450, and the second feature 324 in FIG. 4 is just an example for generating the combination feature 340. Alternatively and/or in addition, these features may be arranged in a different sequence in the combination feature 340.

The combination feature 340 may be inputted into the first and second decoder 312 and 322, respectively. Here, these decoders may have multiple layers and output respective predications. For example, the first decoder 312 may have multiple layers 460, and these layers 460 may process the combination feature 340 and output a predication 462 for the click event. Similarly, the second decoder 322 may have multiple layers 470, and these layers 470 may process the combination feature 340 and output a predication 472 for the conversion event. It is to be understood that the detailed hierarchical structure shown in FIG. 4 is just an example of the predication model 330. Alternatively and/or in addition, the prediction model 330 may have a different hierarchical structure. For example, the first and second encoders 310 and 320 and the first and second decoders 312 and 322 may have more or less layers.

In some implementations of the present disclosure, the first decoder 312 describes an association between a reference feature that is related to a first and a second reference object, and a first reference event that is associated with the first and second reference objects. Here, the first reference object has the same type (for example, the user type) as the first object, the second reference object has the same type (for example, the data type) as the second object, and the first reference event has the same type (for example, the click type) as the first event. In other words, the first decoder 312 describes the association among the user, the data and whether the user clicks the data. The first decoder 312 may be built on a model with initial parameters and be used for converting the combination feature 340 into a prediction 462 indicating whether the user 210 clicks the data 212.

In some implementations of the present disclosure, the first decoder 322 describes an association between a reference feature that is related to a first and a second reference object, and a second reference event that is associated with the first and second reference objects. Here, the first reference object has the same type (for example, the user type) as the first object, the second reference object has the same type (for example, the data type) as the second object, and the second reference event has the same type (for example, the conversion type) as the second event. In other words, the second decoder 322 describes the association among the user, the data and whether the user implements a deeper conversion operation for the data. The second decoder 322 may be built by a model with initial parameters and be used for converting the combination feature 340 into a prediction 472 indicating whether the user 210 implements a deeper conversion operation for the data 212.

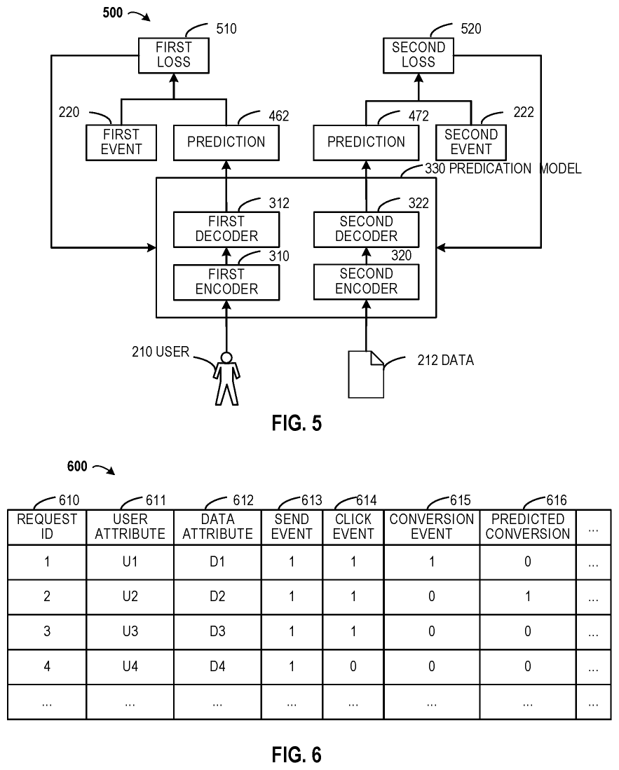

In order to train the prediction model 330, the predictions 462 and 472 may be compared with respective events to determine respective losses. Referring to FIG. 5 for more details about the training procedure, FIG. 5 illustrates an example diagram 500 for training a predication model according to implementations of the present disclosure. As shown in FIG. 5, a first loss 510 may be determined based on a difference between the first event 220 and the prediction 462 of the first event 220. Here, the prediction 462 of the first event 220 is determined based on the combination feature 340 and the first decoder 312. In other words, the first decoder 312 converts the combination feature 340 into the prediction 462 based on the association between the user, the data, and the click event. Further, the first loss 510 may be propagated backward into the prediction model 330 for updating any of the first and second encoders 310 and 320, and the first and second decoders 312 and 322 toward a direction for minimizing the first loss 510. Specifically, parameters for these encoders and decoders may be updated toward a direction that minimizes the first loss 510. With these implementations, events that occur within the short-time window are considered in generating the features for the first and second objects. Therefore, the generated features may reflect a short-time trend of the event, and thus downstream tasks according to the generated features may be implemented in a more accurate way.

Similarly, a second loss 520 may be determined based on a difference between the second event 220 and the prediction 472 of the second event 222. Here, the prediction 472 of the second event 222 is determined based on the combination feature 340 and the second decoder 322. In other words, the second decoder 322 converts the combination feature 340 into the prediction 472 based on the association between the user, the data, and the conversion event. Further, the second loss 520 may be propagated backward into the prediction model 330 for updating any of the first and second encoders 310 and 320, and the first and second decoders 312 and 322 toward a direction for minimizing the second loss 520. Specifically, parameters for these encoders and decoders may be updated toward a direction that minimizes the second loss 520. With these implementations, events related to a long-time window are considered in generating the features for the first and second objects. Therefore, the generated features may reflect a long-time trend of the event. Then, for a long-term window in the future, downstream tasks according to the generated features may be implemented in a more accurate way.

It is to be understood that the above paragraphs describe only one round in the training procedure. Alternatively and/or in addition, the training may be implemented in an iterative way by multiple batches of training samples. Hereinafter, reference will be made to FIG. 6 for the training procedure by training samples. FIG. 6 illustrates an example diagram 600 of a data repository according to implementations of the present disclosure. As shown in FIG. 6, the data repository may have a table structure, where the table comprises multiple columns including various information related to the objects and events. A definition of the data repository may define the content of each column.

For example, the first column represents a request ID 610 for uniquely identifying a request from a user, the second column represents user attribute(s) 611 that may be inputted into the first encoder 310, the third column represents data attribute(s) 612 that may be inputted into the second encoder 312, the fourth column represents a send event 613 indicating that the data is sent to the user, the fifth column represents a click event 614 indicating that the user clicks the data, the sixth column represents a conversion event 615 indicating that the user implements a conversion event for the data, and the seventh column represents a predicted conversion 616 indicating a predicted conversion event outputted by a conversion prediction model, and so on.

Each row in the table may correspond to an individual data item, for example, the first row indicates a data item where request ID=1, user attribute=U1, data attribute=D1, send event=1, click event=1, conversion event=1, and predicted conversion=0, and the like. Based on the definition of the data repository, various training samples may be obtained from the table in FIG. 6. For example, data item(s) of the user may be obtained from the column “user attribute 611,” and data item(s) of the data may be obtained from the column “data attribute 612.” It is to be understood that the user attribute 611 is just an example for illustration, alternatively and/or in addition, the user attribute may include more columns for storing more attributes of the user.

In implementations of the present disclosure, a script language may be defined based on the definition of the data repository in advance for generating respective training samples from the table. For example, samples related to the click event may include three columns: (user attribute 611, data attribute 612, click event 614). Specifically, a script may be written for extracting data items from the above three columns. With respect to the table in FIG. 6, the following samples related to the click event may be generated:
Click event sample 1: (user attribute=U1, data attribute=D1, click event=1);
Click event sample 2: (user attribute=U2, data attribute=D2, click event=1);
Click event sample 3: (user attribute=U3, data attribute=D3, click event=1);
Click event sample 4: (user attribute=U4, data attribute=D4, click event=0).

Here, the click event samples 1-3 belong to the positive sample (click event=1), and the click event sample 4 belongs to the negative sample (click event=0). Similarly, samples related to the conversion event may generated based on a script. The conversion event includes two situations: (user attribute 611, data attribute 612, conversion event 615) and (user attribute 611, data attribute 612, predicted conversion 616). With respect to the data item in a row, if either of the conversion event 615 or the predicted conversion 616 is set to 1, then the data item relates to a positive sample. If both of the conversion event 615 and the predicted conversion 616 are set to 0, then the data item relates to a negative sample. Another script may be written based on the above rules and then the following samples related to the conversion event may be generated:
Conversion event sample 1: (user attribute=U1, data attribute=D1, conversion event=1);
Conversion event sample 2: (user attribute=U2, data attribute=D2, predicted conversion=1);
Conversion event sample 3: (user attribute=U3, data attribute=D3, conversion event=0);
Conversion event sample 4: (user attribute=U4, data attribute=D4, conversion event=0).

Here, the conversion event samples 1-2 belong to the positive sample (conversion event=1 or predicted conversion=1), and the conversion event samples 3-4 belong to the negative sample (conversion event=0). With these implementations, the table may store more training samples and appropriate training samples may be extracted from the table in a simple and effective way by writing corresponding scripts.

It is to be understood that the above data repository is just an example for illustration, alternatively and/or in addition, another data structure may be adopted for storing the relevant data. For example, the direction of the columns and rows may be switched, where the row direction may represent various fields in the table, and the column direction may represent various training samples. Further, although the table in FIG. 6 represents the event in a binary format (where 1 indicates that an event occurs and 0 indicates that no event occurs), the events may be represented in another format. For example, the time point when the event occurs may be recorded, and/or the time duration between the send event and other events may be recorded.

It is to be understood that occurrence frequencies for the click event and conversion events are not the same. Usually, after the data is sent to the user, the user may click the data immediately or after a while. If the user does not click the data within a short time duration (for example, several minutes), it is highly possible that the user is not interested in the data and ignore it. With respect to the users who click the data, only a portion of the users will perform the conversion event (such as buying the commodity or downloading the game promoted in the data). At this point, a frequency rate may be determined between a first occurrence frequency of the first event and a second occurrence frequency of the second event, and then the first and second events may be obtained based on the frequency rate. In other words, in selecting samples in a batch during the training procedure, the rate between the click event samples and the conversion event samples should be in consistent with the real occurrence rate.

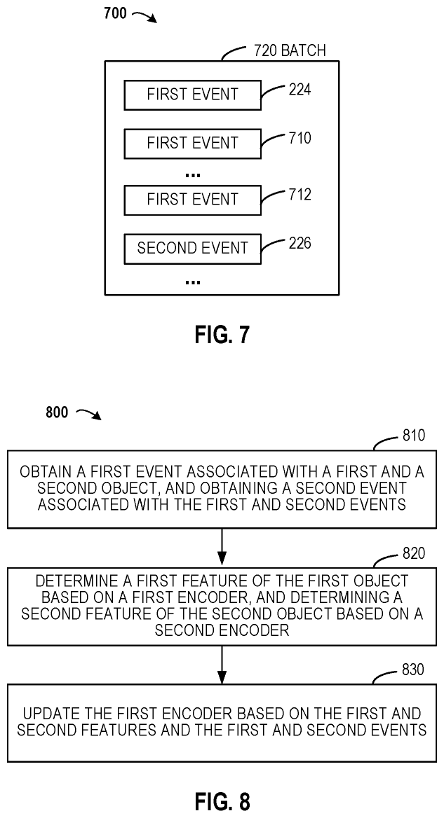

Referring to FIG. 7 for more details about selecting the samples in a batch, FIG. 7 illustrates an example diagram 700 of a batch of training samples according to implementations of the present disclosure. As shown in FIG. 7, samples related to the first and second events may be selected according to the frequency rate. Here, the first occurrence frequency may be above the second occurrence frequency. Supposing only 10% of the users perform the conversion events after the click events, then the rate between the click event samples and the conversion event samples in a batch should be (100-10): 10=9:1. In FIG. 7, 90% of the samples in the batch 720 should be related to the click event (i.e., the first event 224, 710, . . . , and 712) and 10% of the samples should be related to the conversion event (i.e., the second event 226, . . . ). With these implementations, the distribution of the first and second events in each batch may be in consistent with the real distribution according to the historical statistic, therefore the first and second encoders 310 and 320 trained by the batch may conform to the real situation and then increase the performance of the downstream tasks.

Although the above paragraphs describe details of the feature management by taking the user 210 as an example of the first object and taking the data 212 as the second object, alternatively and/or in addition, the first object may correspond to any of the user 210 and the data 212, and the second object may correspond to the other one of the user 210 and the data 212. With these implementations, the structure of the model may be arranged in a flexible way, and accurate features may be extracted for both of the user 210 and the data 212.

In implementations of the present disclosure, the feature management may be adopted in various environments. For example, in a recommendation system, the first event may comprise a click event or an open event for reviewing the data 212, and the second event may comprise various aspects depending on the content of the data 212. For example, in a news feeding environment, the second event may comprise a subscription event, a following event, a comment event, and the like. In an online shopping environment, the second event may comprise an order event, an adding-to-bag event, and the like. In a multimedia service environment, the second event may comprise a download event, and the like. With these implementations, the feature management may be effectively adopted in various environments.

In implementations of the present disclosure, features may be extracted for any objects according to the above procedure, and then a downstream task related to the object may be implemented based on the extracted feature. It is to be understood that the downstream task may be different from the predication task implemented by the predication model 330. For example, in the news feeding environment, user features may be extracted based on the users' historical events and/or other attributes, and then the users may be classified into different clusters. Further, corresponding news may be provided to the users according to their specific cluster. Meanwhile, news features may be extracted based on the historical events related to the news and/or other attributes, and then the news may be classified into different clusters. Further, corresponding news may be provided to the users according to their specific cluster.

The above paragraphs have described details of each step in the feature management solution. The following paragraphs will provide a specific example by adopting the feature management solution in an online advertising environment. It is known that user modeling is a popular machine learning topic which aims to learn active users from media platform based on their historical events and generate the embedding representations. In implementations of the present disclosure, the feature management solution may be adopted in user modeling technology to generate embeddings for the users. Further, the embeddings may be used to find similar users based on a group of seed users provided by advertisers.

Relevant feature management solutions only use the click events within the short-term windows, but fail to capture the deeper events like the conversion in a longer-term window. Further, click events are very dense, hence model training takes a long time on CPU. Compared with the relevant solution, a multi-task machine learning framework is proposed to jointly learn knowledges from both of click and conversion events. Meanwhile, the framework may be extended to incorporate other events based on the specific environment.

In the user modeling environment, the first decoder 312 may process the Click Through Rate (CTR) data (also called as a CTR head) and the second decoder 322 may process the CVR data (also called as a CVR head). Compared with the relevant solution with only the CTR head, the CVR head is added to enhance user embedding representation by considering advertisement conversion events. Here, the CVR head is trained by a send-to-convert dataflow (including the really monitored conversion event from the historical data log and the predicted conversion event). Therefore, most of the conversion events may be captured or predicted without a need for delaying the training procedure by several days. Since the CTR data volume is much more dominant compared with the CVR dataflows, the proposed solution may enhance user feature extraction by considering the context of advertisement conversion and then make a good balance between the click events and the conversion events.

Further, multiple-layer hierarchical structures are adopted for both of the user tower and the advertisement tower, and more information are considered in the model, which also increase the model performance. Meanwhile, on the feature level, some AEO (Application Event Optimization) related features are added to enhance the user representation and boost performance on deep conversion. Moreover, dimensions of embedding size may be increased, for example, from 32 to 64 bits. By doing so, the user embedding has a larger representation space, which also boosts the performance of the downstream task.

The above paragraphs have described details for the feature management. According to implementations of the present disclosure, a method is provided for feature management. Reference will be made to FIG. 8 for more details about the method, where FIG. 8 illustrates an example flowchart of a method 800 for feature management according to implementations of the present disclosure, and a type of the first event is different from a type of the second event. At a block 810, a first event associated with a first and a second object, and a second event associated with the first and second events are obtained. At a block 820, a first feature of the first object is determined based on a first encoder, and a second feature of the second object is determined based on a second encoder. At a block 830, the first encoder is updated based on the first and second features and the first and second events.

In implementations of the present disclosure, updating the first encoder comprises: determining a second loss between the second event and a prediction of the second event that is determined based on the first and second features; and updating the first encoder based on the second loss.

In implementations of the present disclosure, determining the second loss comprises: generating a combination feature based on the first and second features; determining the prediction of the second event based on the combination feature and a second decoder describing an association between a reference feature that is related to a first and a second reference object, and a second reference event that is associated with the first and second reference objects, the first reference object having the same type as the first object, the second reference object having the same type as the second object, and the second reference event having the same type as the second event; and obtaining the second loss based on a difference between the second event and the second prediction of the second event.

In implementations of the present disclosure, generating the combination feature comprises: determining an interaction feature based on the first and second features; and creating the combination feature by a concatenation of the first feature, the interaction feature, and the second feature.

In implementations of the present disclosure, updating the first encoder further comprises: determining a first loss between the first event and a prediction of the first event that is determined based on the first and second features; and updating the first encoder based on the first loss.

In implementations of the present disclosure, determining the first loss comprises: determining the prediction of the first event based on the combination feature and a first decoder describing an association between the reference feature and a first reference event that is associated with the first and second reference objects, the first reference event having the same type as the first event; and obtaining the first loss based on a difference between the first event and the prediction of the first event.

In implementations of the present disclosure, the method 800 further comprises any of: updating the first decoder based on any of the first or second loss; or updating the second decoder based on any of the first or second loss.

In implementations of the present disclosure, the method 800 further comprises: obtaining a data repository that comprises a plurality of data items associated with the first and second objects, and the first and second events; wherein: the first event is obtained by extracting, from the data repository, at least one data item corresponding to the first event based on a definition of the data repository; the second event is obtained by extracting, from the data repository, at least one data item corresponding to the second event based on the definition of the data repository; the first object is obtained by extracting, from the data repository, at least one data item corresponding to the first object based on the definition of the data repository; and the second object is obtained by extracting, from the data repository, at least one data item corresponding to the second object based on the definition of the data repository.

In implementations of the present disclosure, obtaining the first and second events comprises: determining a frequency rate between a first occurrence frequency of the first event and a second occurrence frequency of the second event, the first occurrence frequency being above the second occurrence frequency; and obtaining the first and second events based on the frequency rate.

In implementations of the present disclosure, the first object comprises one of: a user of an application, and data that is provided to the user of the application; the second object comprises a further one of the user and data; and the first event comprises any of: a click event or an open event, and the second event comprises any of: a subscription event, an order event, a download event, an adding-to-bag event, a following event, or a comment event, the second event occurring after the first event.

In implementations of the present disclosure, the method 800 further comprises: extracting a feature of an object based on the first encoder; and implementing a downstream task of the object based on the extracted feature.

According to implementations of the present disclosure, an apparatus is provided for feature management. The apparatus comprises: an obtaining unit, being configured for obtaining a first event associated with a first and a second object, and obtaining a second event associated with the first and second events; a determining unit, being configured for determining a first feature of the first object based on a first encoder, and determining a second feature of the second object based on a second encoder; and an updating unit, being configured for updating the first encoder based on the first and second features and the first and second events. Further, the apparatus may comprise other units for implementing other steps in the method 800.

According to implementations of the present disclosure, an electronic device is provided for implementing the method 800. The electronic device comprises: a computer processor coupled to a computer-readable memory unit, the memory unit comprising instructions that when executed by the computer processor implements a method for feature management. The method comprises: obtaining a first event associated with a first and a second object, and obtaining a second event associated with the first and second events, a type of the first event being different from a type of the second event; determining a first feature of the first object based on a first encoder, and determining a second feature of the second object based on a second encoder; and updating the first encoder based on the first and second features and the first and second events.

In implementations of the present disclosure, updating the first encoder comprises: determining a second loss between the second event and a prediction of the second event that is determined based on the first and second features; and updating the first encoder based on the second loss.

In implementations of the present disclosure, determining the second loss comprises: generating a combination feature based on the first and second features; determining the prediction of the second event based on the combination feature and a second decoder describing an association between a reference feature that is related to a first and a second reference object, and a second reference event that is associated with the first and second reference objects, the first reference object having the same type as the first object, the second reference object having the same type as the second object, and the second reference event having the same type as the second event; and obtaining the second loss based on a difference between the second event and the second prediction of the second event.

In implementations of the present disclosure, generating the combination feature comprises: determining an interaction feature based on the first and second features; and creating the combination feature by a concatenation of the first feature, the interaction feature, and the second feature.

In implementations of the present disclosure, updating the first encoder further comprises: determining a first loss between the first event and a prediction of the first event that is determined based on the first and second features; and updating the first encoder based on the first loss.

In implementations of the present disclosure, determining the first loss comprises: determining the prediction of the first event based on the combination feature and a first decoder describing an association between the reference feature and a first reference event that is associated with the first and second reference objects, the first reference event having the same type as the first event; and obtaining the first loss based on a difference between the first event and the prediction of the first event.

In implementations of the present disclosure, the method 800 further comprises any of: updating the first decoder based on any of the first or second loss; or updating the second decoder based on any of the first or second loss.

In implementations of the present disclosure, the method 800 further comprises: obtaining a data repository that comprises a plurality of data items associated with the first and second objects, and the first and second events; wherein: the first event is obtained by extracting, from the data repository, at least one data item corresponding to the first event based on a definition of the data repository; the second event is obtained by extracting, from the data repository, at least one data item corresponding to the second event based on the definition of the data repository; the first object is obtained by extracting, from the data repository, at least one data item corresponding to the first object based on the definition of the data repository; and the second object is obtained by extracting, from the data repository, at least one data item corresponding to the second object based on the definition of the data repository.

In implementations of the present disclosure, obtaining the first and second events comprises: determining a frequency rate between a first occurrence frequency of the first event and a second occurrence frequency of the second event, the first occurrence frequency being above the second occurrence frequency; and obtaining the first and second events based on the frequency rate.

In implementations of the present disclosure, the first object comprises one of: a user of an application, and data that is provided to the user of the application; the second object comprises a further one of the user and data; and the first event comprises any of: a click event or an open event, and the second event comprises any of: a subscription event, an order event, a download event, an adding-to-bag event, a following event, or a comment event, the second event occurring after the first event.

In implementations of the present disclosure, the method 800 further comprises: extracting a feature of an object based on the first encoder; and implementing a downstream task of the object based on the extracted feature.

According to implementations of the present disclosure, a computer program product, the computer program product comprising a computer readable storage medium having program instructions embodied therewith, the program instructions executable by an electronic device to cause the electronic device to perform the method 800.

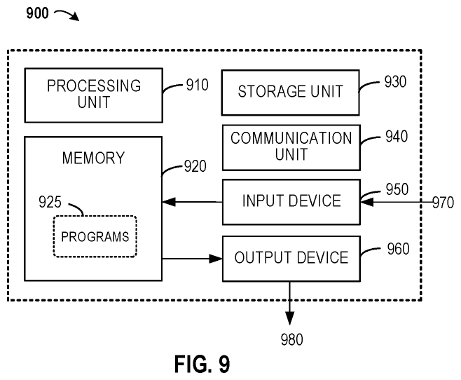

FIG. 9 illustrates a block diagram of a computing device 900 in which various implementations of the present disclosure can be implemented. It would be appreciated that the computing device 900 shown in FIG. 9 is merely for purpose of illustration, without suggesting any limitation to the functions and scopes of the present disclosure in any manner. The computing device 900 may be used to implement the above method 1000 in implementations of the present disclosure. As shown in FIG. 9, the computing device 900 may be a general-purpose computing device. The computing device 900 may at least comprise one or more processors or processing units 910, a memory 920, a storage unit 930, one or more communication units 940, one or more input devices 950, and one or more output devices 960.

The processing unit 910 may be a physical or virtual processor and can implement various processes based on programs stored in the memory 920. In a multi-processor system, multiple processing units execute computer executable instructions in parallel so as to improve the parallel processing capability of the computing device 900. The processing unit 910 may also be referred to as a central processing unit (CPU), a microprocessor, a controller, or a microcontroller.

The computing device 900 typically includes various computer storage medium. Such medium can be any medium accessible by the computing device 900, including, but not limited to, volatile and non-volatile medium, or detachable and non-detachable medium. The memory 920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 930 may be any detachable or non-detachable medium and may include a machine-readable medium such as a memory, flash memory drive, magnetic disk, or another other media, which can be used for storing information and/or data and can be accessed in the computing device 900.

The computing device 900 may further include additional detachable/non-detachable, volatile/non-volatile memory medium. Although not shown in FIG. 9, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 940 communicates with a further computing device via the communication medium. In addition, the functions of the components in the computing device 900 can be implemented by a single computing cluster or multiple computing machines that can communicate via communication connections. Therefore, the computing device 900 can operate in a networked environment using a logical connection with one or more other servers, networked personal computers (PCs) or further general network nodes.

The input device 950 may be one or more of a variety of input devices, such as a mouse, keyboard, tracking ball, voice-input device, and the like. The output device 960 may be one or more of a variety of output devices, such as a display, loudspeaker, printer, and the like. By means of the communication unit 940, the computing device 900 can further communicate with one or more external devices (not shown) such as the storage devices and display device, with one or more devices enabling the user to interact with the computing device 900, or any devices (such as a network card, a modem, and the like) enabling the computing device 900 to communicate with one or more other computing devices, if required. Such communication can be performed via input/output (I/O) interfaces (not shown).

In some implementations, instead of being integrated in a single device, some, or all components of the computing device 900 may also be arranged in cloud computing architecture. In the cloud computing architecture, the components may be provided remotely and work together to implement the functionalities described in the present disclosure. In some implementations, cloud computing provides computing, software, data access and storage service, which will not require end users to be aware of the physical locations or configurations of the systems or hardware providing these services. In various implementations, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The functionalities described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out the methods of the subject matter described herein may be written in any combination of one or more programming languages. The program code may be provided to a processor or controller of a general-purpose computer, special purpose computer, or other programmable data processing apparatus such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are illustrated in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

From the foregoing, it will be appreciated that specific implementations of the presently disclosed technology have been described herein for purposes of illustration, but that various modifications may be made without deviating from the scope of the disclosure. Accordingly, the presently disclosed technology is not limited except as by the appended claims.

Implementations of the subject matter and the functional operations described in the present disclosure can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media, and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, the use of “or” is intended to include “and/or”, unless the context clearly indicates otherwise.

While the present disclosure contains many specifics, these should not be construed as limitations on the scope of any disclosure or of what may be claimed, but rather as descriptions of features that may be specific to particular implementations of particular disclosures. Certain features that are described in the present disclosure in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are illustrated in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations. Only a few implementations and examples are described and other implementations, enhancements and variations can be made based on what is described and illustrated in the present disclosure.

What is claimed is:

1. A method for feature management, comprising:
obtaining a first event associated with a first and a second object, and obtaining a second event associated with the first and second events, a type of the first event being different from a type of the second event;
determining a first feature of the first object based on a first encoder, and determining a second feature of the second object based on a second encoder; and
updating the first encoder based on the first and second features and the first and second events.

2. The method of claim 1, wherein updating the first encoder comprises:
determining a second loss between the second event and a prediction of the second event that is determined based on the first and second features; and
updating the first encoder based on the second loss.

3. The method of claim 2, wherein determining the second loss comprises:
generating a combination feature based on the first and second features;
determining the prediction of the second event based on the combination feature and a second decoder describing an association between a reference feature that is related to a first and a second reference object, and a second reference event that is associated with the first and second reference objects, the first reference object having the same type as the first object, the second reference object having the same type as the second object, and the second reference event having the same type as the second event; and
obtaining the second loss based on a difference between the second event and the second prediction of the second event.

4. The method of claim 3, wherein generating the combination feature comprises:
determining an interaction feature based on the first and second features; and
creating the combination feature by a concatenation of the first feature, the interaction feature, and the second feature.

5. The method of claim 3, wherein updating the first encoder further comprises:
determining a first loss between the first event and a prediction of the first event that is determined based on the first and second features; and
updating the first encoder based on the first loss.

6. The method of claim 5, wherein determining the first loss comprises:
determining the prediction of the first event based on the combination feature and a first decoder describing an association between the reference feature and a first reference event that is associated with the first and second reference objects, the first reference event having the same type as the first event; and
obtaining the first loss based on a difference between the first event and the prediction of the first event.

7. The method of claim 6, further comprising any of:
updating the first decoder based on any of the first or second loss; or
updating the second decoder based on any of the first or second loss.

8. The method of claim 1, further comprising: obtaining a data repository that comprises a plurality of data items associated with the first and second objects, and the first and second events; wherein:
the first event is obtained by extracting, from the data repository, at least one data item corresponding to the first event based on a definition of the data repository;
the second event is obtained by extracting, from the data repository, at least one data item corresponding to the second event based on the definition of the data repository;
the first object is obtained by extracting, from the data repository, at least one data item corresponding to the first object based on the definition of the data repository; and
the second object is obtained by extracting, from the data repository, at least one data item corresponding to the second object based on the definition of the data repository.

9. The method of claim 1, wherein obtaining the first and second events comprises:
determining a frequency rate between a first occurrence frequency of the first event and a second occurrence frequency of the second event, the first occurrence frequency being above the second occurrence frequency; and
obtaining the first and second events based on the frequency rate.

10. The method of claim 1, wherein:
the first object comprises one of: a user of an application, and data that is provided to the user of the application;
the second object comprises a further one of the user and data; and
the first event comprises any of: a click event or an open event, and the second event comprises any of: a subscription event, an order event, a download event, an adding-to-bag event, a following event, or a comment event, the second event occurring after the first event.

11. The method of claim 1, further comprising:
extracting a feature of an object based on the first encoder; and
implementing a downstream task of the object based on the extracted feature.

12. An electronic device, comprising a computer processor coupled to a computer-readable memory unit, the memory unit comprising instructions that when executed by the computer processor implements a method for feature management, the method comprising:
obtaining a first event associated with a first and a second object, and obtaining a second event associated with the first and second events, a type of the first event being different from a type of the second event;
determining a first feature of the first object based on a first encoder, and determining a second feature of the second object based on a second encoder; and
updating the first encoder based on the first and second features and the first and second events.

13. The device of claim 12, wherein updating the first encoder comprises:
determining a second loss between the second event and a prediction of the second event that is determined based on the first and second features; and
updating the first encoder based on the second loss.

14. The device of claim 13, wherein determining the second loss comprises:
generating a combination feature based on the first and second features;
determining the prediction of the second event based on the combination feature and a second decoder describing an association between a reference feature that is related to a first and a second reference object, and a second reference event that is associated with the first and second reference objects, the first reference object having the same type as the first object, the second reference object having the same type as the second object, and the second reference event having the same type as the second event; and
obtaining the second loss based on a difference between the second event and the second prediction of the second event.

15. The device of claim 13, wherein updating the first encoder further comprises:
determining the prediction of the first event based on the combination feature and a first decoder describing an association between the reference feature and a first reference event that is associated with the first and second reference objects, the first reference event having the same type as the first event;
obtaining the first loss based on a difference between the first event and the prediction of the first event; and
updating the first encoder based on the first loss.

16. The device of claim 15, further comprising any of: updating the first decoder based on any of the first or second loss; or updating the second decoder based on any of the first or second loss, wherein obtaining the first and second events comprises:
determining a frequency rate between a first occurrence frequency of the first event and a second occurrence frequency of the second event, the first occurrence frequency being above the second occurrence frequency; and
obtaining the first and second events based on the frequency rate.

17. The device of claim 12, further comprising: obtaining a data repository that comprises a plurality of data items associated with the first and second objects, and the first and second events; wherein:
the first event is obtained by extracting, from the data repository, at least one data item corresponding to the first event based on a definition of the data repository;
the second event is obtained by extracting, from the data repository, at least one data item corresponding to the second event based on the definition of the data repository;
the first object is obtained by extracting, from the data repository, at least one data item corresponding to the first object based on the definition of the data repository; and
the second object is obtained by extracting, from the data repository, at least one data item corresponding to the second object based on the definition of the data repository.

18. The device of claim 12, wherein:
the first object comprises one of: a user of an application, and data that is provided to the user of the application;
the second object comprises a further one of the user and data; and
the first event comprises any of: a click event or an open event, and the second event comprises any of: a subscription event, an order event, a download event, an adding-to-bag event, a following event, or a comment event, the second event occurring after the first event.

19. The device of claim 12, further comprises:
extracting a feature of an object based on the first encoder; and
implementing a downstream task of the object based on the extracted feature.

20. A non-transitory computer program product, the non-transitory computer program product comprising a computer readable storage medium having program instructions embodied therewith, the program instructions executable by an electronic device to cause the electronic device to perform a method for feature management, the method comprising:
obtaining a first event associated with a first and a second object, and obtaining a second event associated with the first and second events, a type of the first event being different from a type of the second event;
determining a first feature of the first object based on a first encoder, and determining a second feature of the second object based on a second encoder; and
updating the first encoder based on the first and second features and the first and second events.
